(19) United States
(12) Patent Application Publication
(10) Pub. No.: US 2011/0052017 A1
(43) Pub. Date: Mar. 3, 2011

(54) Processor for Pathologic Diagnosis and Processing System for Pathologic Diagnosis

(75) Inventors: Mitsuyoshi Suwaki, Tokyo (JP); Yoshihiro Kawano, Tokyo (JP); Masaaki Yamagishi, Tokyo (JP); Takashi Okuno, Tokyo (JP); Iwao Kanamori, Tokyo (JP)

(73) Assignee: OLYMPUS CORPORATION, Tokyo (JP)

(21) Appl. No.: 12/859,584

(22) Filed: Aug. 19, 2010

(30) Foreign Application Priority Data
Aug. 25, 2009 (JP) 2009-194049

(51) Int. Cl. G06K 9/00

(52) U.S. Cl. 382/128

(57) ABSTRACT

The object is to enable a pathologist to appropriately conduct a diagnosis as well as enabling the pathologist to quickly proceed with the pathologic diagnosis. A processor for pathologic diagnosis comprises: a diagnosis receiver unit which receives identification information of a patient and diagnosis request information; a pathologist information storage unit which stores information of pathologists; a pathologist selection unit which makes an inquiry to the pathologist information storage unit based on the diagnosis request information received by the diagnosis receiver unit, and selects a pathologist suitable for the diagnosis request information; an image transmission, commander unit which issues a command to send digital image data of the patient stored in an image storage server, to a local server connected to a second network belonged to by a pathologist terminal used by the pathologist selected by the pathologist selection unit; and a diagnosis requesting unit which sends a request for diagnosis of the specimen of the patient, to the pathologist selected by the pathologist selection unit, after the digital image data has been sent to the local server by the image transmission commander unit.

### BACKGROUND OF THE INVENTION

1. Field of the Invention

The present invention relates to a processor for pathologic diagnosis and a processing system for pathologic diagnosis.

This application is based on Japanese Patent Application No. 2009-194049, the content of which is incorporated herein by reference.

2. Description of Related Art

Heretofore, pathologic diagnosis, in which a slice of lesioned tissue taken from the body of a patient is morphologically diagnosed through microscopic observation, has been employed as one of diagnostic methods of diseases. The pathologic diagnosis is often conducted to ensure the final determination of diagnosis, and the result of this diagnosis imposes a great influence on the therapeutic plan. Accordingly, the pathologic diagnosis is desirably done by a highly specialized pathologist with full of experiences on cases of the disease to be diagnosed.

On the other hand, there is known a system in which bio-information of a user or a diagnostic image of a patient is sent to a terminal used by a distant doctor who carries out a remote diagnosis (for example, refer to Japanese Unexamined Patent Application, Publication No. 2002-119484 and Japanese Unexamined Patent Application, Publication No. 2005-182698). The system of Japanese Unexamined Patent Application, Publication No. 2002-119484 is intended to use for medical checkups of healthy people. If any abnormality is found through the diagnosis, the system selects of a doctor corresponding to the abnormality, and makes a request for treatment to the selected doctor. The system of Japanese Unexamined Patent Application, Publication No. 2005-182698 is intended to use for diagnoses with X-ray images or ultrasound images, and makes a request for diagnosis to a specialist doctor who has been selected according to the symptom of the patient.

Pathologists are chronically in short. Some hospitals and local regions lack enough number of pathologists. In such a site of medical practice, as the number of pathologists to whom clinicians can ask for pathologic diagnosis is limited, clinicians have to ask for diagnosis to pathologists who are not very specialized in the case of interest. Moreover, it is difficult to provide satisfactory pathologic diagnoses which can meet respective diagnosis requests because the diagnosis results may not be always quickly obtainable depending on the working schedule of pathologists, for example.

On the other hand, if a request for pathologic diagnosis is made to a distant pathologist, like the cases of Japanese Unexamined Patent Application, Publication No. 2002-119484 and Japanese Unexamined Patent Application, Publication No. 2005-182698, the distant area also needs to be in an environment in which the sample can be observed under an equivalent condition to microscopic observation in terms of the image magnification and the resolution. For this reason, a method of creating a virtual slide image, which is a quite high resolution digital image, of a specimen mounted on a slide glass, and of ending the image data thereof to a distant pathologist, can be taken into consideration.

The systems of Japanese Unexamined Patent Application, Publication No. 2002-119484 and Japanese Unexamined Patent Application, Publication No. 2005-182698 are not supposed to send such quite large data to distant areas. Accordingly, when a request for pathologic diagnosis is made to a distant pathologist, it takes a long time to send the data of virtual slide images, disabling the pathologist from quickly proceeding with the diagnosis.

### BRIEF SUMMARY OF THE INVENTION

The present invention provides a processor for pathologic diagnosis and a processing system for pathologic diagnosis, which enable a pathologist to appropriately conduct a diagnosis as well as enabling the pathologist to quickly proceed with the pathologic diagnosis.

A first aspect of the present invention is a processor for pathologic diagnosis, which is connected to a first network of a processing system for pathologic diagnosis comprising: an image storage server which is connected to the first network, and which stores digital image data of a specimen taken from a patient, in an associated manner with identification information of the patient; pathologist terminals which are connected to a second network, which is connected to the first network, that is capable of higher speed communication than the first network, and which are used by previously registered pathologists; and a local server which is connected to the second network, wherein the processor for pathologic diagnosis comprises: a diagnosis receiver unit which receives the identification information of the patient and diagnosis request information; a pathologist information storage unit which stores information of the pathologists; a pathologist selection unit which makes an inquiry to the pathologist information storage unit based on the diagnosis request information received by the diagnosis receiver unit, and selects a pathologist suitable for the diagnosis request information; an image transmission commander unit which issues a command to send digital image data of the patient stored in the image storage server, to a local server connected to the second network belonged to by a pathologist terminal used by the pathologist selected by the pathologist selection unit; and a diagnosis requesting unit which sends a request for diagnosis of the specimen of the patient, to the pathologist selected by the pathologist selection unit, after the digital image data has been sent to the local server by the image transmission commander unit.

According to the first aspect of the present invention, when the request for pathologic diagnosis of the specimen is received by the diagnosis receiver unit, a pathologist suitable for the content of the diagnosis request is selected among pathologists who have been previously registered in the pathologist information storage unit, by the pathologist selection unit, and the diagnosis request is sent to the selected pathologist by the diagnosis requesting unit. When the pathologist receives the diagnosis request, he/she makes an access from the pathologist terminal used by him/herself to the local server belonged to by the pathologist terminal. Thereby, the pathologist can conduct a pathologic diagnosis by viewing the digital image data that has been sent by the image transmission commander unit before the transmission of the diagnosis request.

In this case, as compared to the case of directly accessing to the image storage server connected through the first network, the pathologist terminal is more able to quickly acquire the digital image through the second network. By so doing, the pathologist is enabled to quickly proceed with to the pathologic diagnosis.

In the first aspect, the pathologist selection unit may also select a plurality of the such suitable pathologists by prioritizing them, and the image transmission commander unit may issue a command to send the digital image data to respective local servers belonged to by pathologist terminals used by the plurality of pathologists, sequentially in the order of priority of pathologists.

By so doing, the digital image data can be sent to the local servers belonged to by respective pathologist terminals used by a plurality of highly prioritized pathologists, before the transmission of the diagnosis request. Accordingly, even if some of the plurality of selected pathologists reject to diagnose, and another diagnosis request has to be made to a different pathologist, it is possible for the different pathologist to quickly acquire the digital image data by using the pathologist terminal of him/herself.

In the above-mentioned first aspect, there may also be provided a response receiver unit which receives a response regarding the acceptance or rejection of the diagnosis, in reply to the diagnosis request from the diagnosis requesting unit, and if the response receiver unit receives a response from the pathologist informing that he/she rejects the diagnosis, the image transmission commander unit may issue a command to send the digital image data to the local server belonged to by a pathologist terminal used by a pathologist prioritized next to the pathologist to whom the digital image data has already been sent, and the diagnosis requesting unit may send a diagnosis request to a pathologist prioritized immediately next to the pathologist to whom the latest diagnosis request has been sent.

By so doing, if a pathologist rejects to diagnose, another diagnosis request can be made to the next pathologist sequentially in the order of priority of pathologists, while the digital image data has been previously sent to local servers belonged to by the pathologist terminals used by the pathologists who might be requested to diagnose with a sufficiently high possibility. Accordingly, even if the diagnosis request is rejected again and again by top prioritized pathologists, a low prioritized pathologist who accepts the diagnosis request is able to quickly conduct a diagnosis by using the digital image.

In addition, in the above-mentioned first aspect, the image transmission commander unit may also determine whether or not the digital image data has already been sent to the addressed local server, and if the data has already been sent thereto, the unit may cancel the transmission of the digital image data.

By so doing, digital image data can be prevented from being overlappingly stored in a same sever, and therefore loads on local servers can be alleviated.

Moreover, in the above-mentioned first aspect, there may also be provided a diagnosis completion receiver unit which receives a notification from the pathologist terminal informing that the diagnosis has been completed, and an image deletion commander unit which issues a command to the local server belonged to by the pathologist terminal, from which the notification of the completion of diagnosis has been received by the diagnosis completion receiver unit, so that the digital image data be deleted.

By so doing, the digital image which becomes unnecessary anymore can be promptly deleted from the local server, and therefore loads on local servers can be alleviated.

Furthermore, in the above-mentioned first aspect, there may also be provided a recommendation receiver unit which receives a recommendation for a different pathologist from the pathologist to whom the diagnosis request has been sent from the diagnosis requesting unit, and if the recommendation for the different pathologist is received by the recommendation receiver unit, the image transmission commander unit may issue a command to send the digital image data to the local server belonged to by a pathologist terminal used by the different pathologist, and thereafter the diagnosis requesting unit may send a diagnosis request to the different pathologist.

By so doing, when the pathologist first receiving the diagnosis request makes a recommendation for a different pathologist who is more suitable for the diagnosis, the digital image data is sent to a local server belonged to by a pathologist terminal used by the recommended pathologist, and a diagnosis request is made to the recommended pathologist. Accordingly, the diagnosis can be quickly conducted by a more suitable pathologist. In this case, when the recommended pathologist receives a diagnosis request, he/she is also able to quickly acquire the digital image data that has been previously sent to the local server belonged to by the pathologist terminal of him/herself, and therefore he/she is able to quickly conduct the pathologic diagnosis.

A second aspect of the present invention is a processing system for pathologic diagnosis which comprises: a first network; an image storage server which is connected to the first network, and which stores digital image data of a specimen taken from a patient, in an associated manner with identification information of the patient; a second network which is connected to the first network and is capable of higher speed communication than the first network; pathologist terminals which are connected to the second network, and are used by previously registered pathologists; a local server which is connected to the second network; and a processor for pathologic diagnosis according to any one of the above-mentioned processors being connected to the first network.

In addition, in the above-mentioned second aspect, there may also be provided a primary doctor terminal which is connected to the second network and is used by a personal doctor in charge of the patient, and the image transmission commander unit may issue a command to send the digital image data to a local server belonged to by the primary doctor terminal.

By so doing, the personal doctor in charge is also able to quickly acquire the digital image data.

According to the present invention, an effect which enables a pathologist to appropriately conduct a diagnosis as well as enabling the pathologist to quickly proceed with the pathologic diagnosis, can be provided.

### BRIEF DESCRIPTION OF THE SEVERAL VIEWS OF THE DRAWINGS

FIG. 1 is an overall structural diagram of a processing system for pathologic diagnosis according to one embodiment of the present invention.

FIG. 2 is a functional block diagram showing functions of the processor for pathologic diagnosis according to one embodiment of the present invention, in a developed arrangement.

FIG. 3 is a functional block diagram showing a modified example of the processor for pathologic diagnosis of FIG. 2.

### DETAILED DESCRIPTION OF THE INVENTION

Hereunder is a description of a pathologic diagnosis processor 1 and a pathologic diagnosis-processing system 100 according to one embodiment of the present invention, with reference to the drawings.

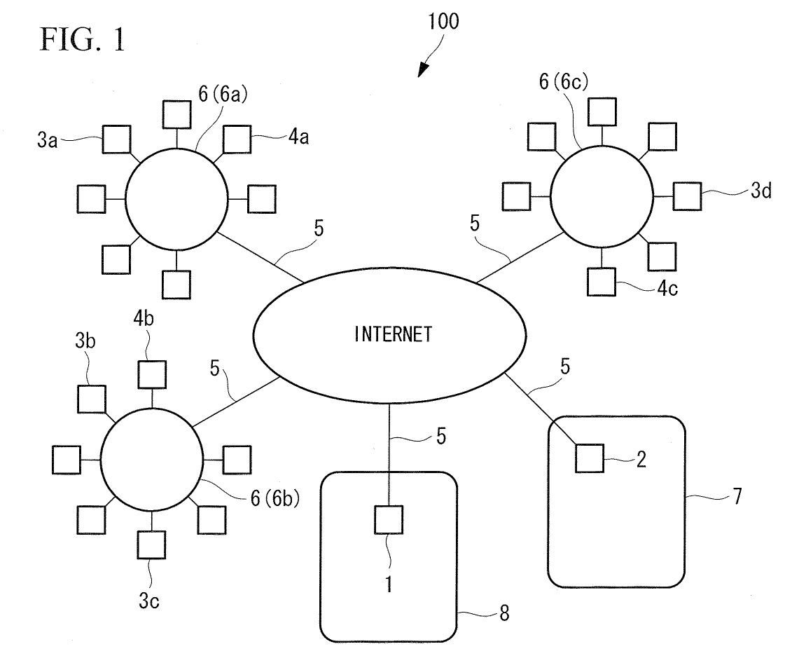

As shown in FIG. 1, the pathologic diagnosis-processing system 100 according to this embodiment comprises an image database server (IDB server, image storage server) 2 for storing virtual slide (VS) image data of specimens taken from patients, the pathologic diagnosis processor (RPS: remote pathology system) 1 according to this embodiment, pathologist terminals 3a to 3d used by pathologists who have been registered in the RPS 1, and local servers 4a to 4c belonged to by the respective pathologist terminals 3a to 3d. These are connected with each other via networks 5 and 6.

The IDB server 2 is installed in an inspection agency 7 which creates and manages VS images of specimens. The RPS 1 is installed in a primary hospital 8 of the patient. The primary hospital 8 refers to a medium-to-small sized clinic or hospital where primary cares are done and where no or an insufficient number of pathologists work.

The RPS 1, the IDB server 2, and the local servers 4a to 4c are connected with each other via an internet (first network) 5.

The respective pathologist terminals 3a to 3d are connected to the local servers 4a to 4c belonged to by themselves, via a high speed network 6 serving as a second network, and are connected to the internet 5 via these local servers 4a to 4c. The high speed network 6 is capable of higher speed communication than the internet 5 which connects the local servers 4a to 4c and the IDB server 2.

Specifically speaking, a local server 4a is connected to a plurality of (six in this embodiment) pathologist terminals including the pathologist terminal 3a, via a high speed network 6a. Moreover, a local server 4b is connected to a plurality of pathologist terminals including the pathologist terminals 3b and 3c, via a high speed network 6b. Furthermore, a local server 4c is connected to a plurality of pathologist terminals including the pathologist terminal 3d, via a high speed network 6c. For example, the local servers 4a to 4c can be exemplified by domestic servers in hospitals at which pathologists work and which are distant from the primary hospital 8 of the patient. The high speed network 6 can be exemplified by LAN which is constructed in each hospital and has a sufficiently high communication speed, or a leased line which respectively connects the pathologist terminals 3a to 3d and the local servers 4a to 4c.

The inspection agency 7 prepares a specimen of a lesioned site of a patient that has been sent from the primary hospital 8 of the patient, on a slide glass to create a virtual slide (VS). Also, the inspection agency 7 uses a virtual slide system to capture a VS image by scanning the VS with an object lens to thereby create digital data of the VS image. Then, the thus created VS data is stored in the IDB server 2.

Specifically speaking, the virtual slide system comprises: a microscope which has an illumination optical system, an imager, and a stage that holds a sample and can be moved in a predetermined direction; a controller in charge of the overall control of the system including the operational control of these items; and the IDB server 2 which stores a digital image captured by the imager. This controller subdivides the observational region of a specimen (sample) on the slide glass into minute regions according to the magnification, then sequentially scans these subdivided regions by moving the stage to allow the imager to capture their images, adds the positional information of respectively captured regions relative to the entire region of the whole image, and stores these data in the IDB server 2. At this time, when an object lens of ×20 magnification or ×40 magnification is used, a high definition VS image having an equivalently high resolution to that of the microscopic observation of VS, is created. The thus actually created VS image has an extremely large data size exceeding one terabyte, although the data size depends on the size of the specimen.

In addition, to the slide glass is attached a barcode recorded with a specimen ID that has been given to each specimen by the primary hospital 8. By scanning the barcode together with the specimen, the VS image and the specimen ID can be stored in an associated manner into the IDB server 2.

When new VS image data is stored in this way, the IDB server 2 sends the VS image data and the associated specimen ID information to the RPS 1. By so doing, the RPS 1 can obtain information regarding the completion of the creation of the VS image data of the patient.

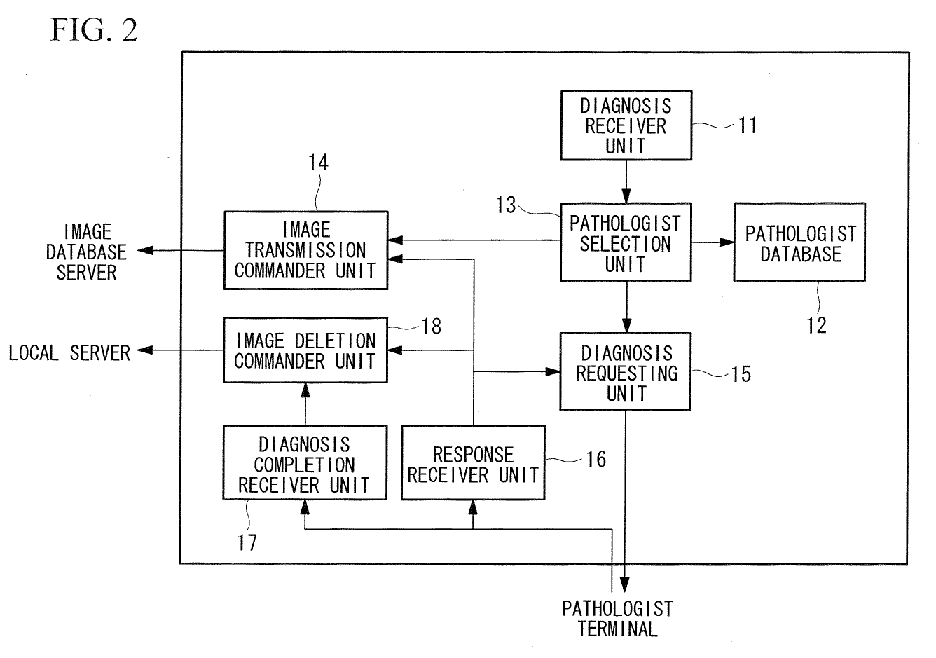

As shown in FIG. 2, the RPS 1 comprises: a diagnosis receiver unit 11 which receives a request for pathologic diagnosis; a pathologist database (pathologist information storage unit) 12 which stores information of previously registered pathologists; a pathologist selection unit 13 which selects pathologist(s) to request for diagnosis, among the registered pathologists in the pathologist database 12; an image transmission commander unit 14 which issues a command to the VS image data to one or more of local servers 4a to 4c belonged to by the selected pathologist(s); a diagnosis requesting unit 15 which sends a diagnosis request to the selected pathologist(s); a response receiver unit 16 which receives a response in reply to the diagnosis request from the pathologist(s); a diagnosis completion receiver unit 17 which receives a notification from a pathologist informing that the diagnosis has been completed; and an image deletion commander unit 18 which issues a command to delete the VS image data that has been sent to the concerned one or more of local servers 4a to 4c belonged to by the pathologist(s), based on by the command from the diagnosis completion receiver unit 17.

The diagnosis receiver unit 11 receives a request for pathologic diagnosis of a patient from an operator who inputs a patient ID (identification information) given to each patient by the primary hospital 8, diagnosis request information, and a specimen ID, into the RPS 1. The diagnosis request information means information to be referred to when selecting a pathologist to request for diagnosis, and when the pathologist conducts the diagnosis, which contains, for example, the gender of the patient, his/her date of birth, the site of a tissue of the specimen, the name of the disease diagnosed by the personal doctor, and the due date to submit the examination result.

The pathologist database 12 stores respective pathologists and information of the respective pathologists in an associated manner. The pathologist information means information which contains the name, the place of work, etc. of the pathologist, and other information needed for determining the pathologist to make the request for pathologic diagnosis, including, for example, the specialized field, the working schedule, IDs of patients diagnosed by the pathologist in the past, the educational background, and the nationality. Moreover, the pathologist database 12 stores respective pathologists and the local servers 4a to 4c belonged to by the pathologist terminals 3a to 3d used by the respective pathologists, in an associated manner.

The pathologist selection unit 13 selects suitable pathologists by making an inquiry about the diagnosis request information received by the diagnosis receiver unit 11, to the pathologist database 12. At this time, the pathologist selection unit 13 is able to pick up, for example, some kinds of information to inquire to the pathologist database 12, out of all kinds of information included in the diagnosis request information, by the operation of the operator.

For example, in the case of a pathologic diagnosis of breast cancer needing an urgent treatment, the specialized field and the working schedule are picked up from all kinds of information of pathologists, and an inquiry about these picked-up items is made. By so doing, pathologists who specialize in breast cancer, who are at work at the present time, and who can promptly start the diagnosis, can be selected.

In addition, the pathologist selection unit 13 prioritizes the selected pathologists. The prioritization method is, for example, a known method which scores the respective items of the information of pathologists on a high-to-low scale in the order of diagnostic importance.

Hereinunder, for the sake of brief description, an assumption is made such that four pathologists are selected by the pathologist selection unit 13, and these four pathologists respectively use the pathologist terminal 3a, the pathologist terminal 3b, the pathologist terminal 3c, and the pathologist terminal 3d, in the order of priority of pathologists. In addition, in this assumption, the pathologist terminal 3a belongs to the local server 4a, the pathologist terminal 3b and the pathologist terminal 3c belong to the local server 4b, and the pathologist terminal 3d belongs to the local server 4c.

When the information regarding the completion of the creation of a VS image of a patient is received from the IDB server 2, the image transmission commander unit 14 sends a transmission request to the IDB server 2 to send the VS image data to the local servers 4a and 4b which correspond to a predetermined number of top prioritized pathologists, for example, top three pathologists, among the pathologists selected by the pathologist selection unit 13. At this time, the image transmission commander unit 14 determines whether or not there are any overlapping VS image data transmissions to be sent to a same server, namely the local server 4a or 4b. If there are any overlapping transmissions to be sent to the same local server 4b, the image transmission commander unit 14 cancels one of these transmissions to be sent to the same local server 4b.

In the case of this embodiment, the local server 4b corresponding to the second and the third prioritized pathologists, that is to say, the local server 4b belonged to by the pathologist terminal 3b and the pathologist terminal 3c, are shared. Therefore, for example, the VS image data transmission to the third prioritized pathologist is canceled. Moreover, when sending VS image data at the second time or some another time, the image transmission commander unit 14 determines whether or not the VS image data has already been sent to the addressed local server, and if it has already been sent, the image transmission commander unit 14 cancels the transmission. By so doing, overlapping VS image data transmissions to a same sever of the local servers 4a to 4c can be prevented.

In addition, in reply to the transmission request from the image transmission commander unit 14, the IDB server 2 sends the notification regarding completion of the VS image data transmissions to the local servers 4a and 4b, when completed, to the RPS 1.

When the notification regarding the completion of VS image data transmissions is received from the IDB server 2, the diagnosis requesting unit 15 sends a notification of diagnosis request to the pathologist terminal 3a used by the first prioritized pathologist, among the pathologists selected by the pathologist selection unit 13, together with an inquiry to ask if he/she can do the diagnosis or not.

In reply to the diagnosis request sent from the diagnosis requesting unit 15, if a response from the pathologist informing that he/she can do the diagnosis is received, the response receiver unit 16 sends this information to the image deletion commander unit 18.

On the other hand, if a response from the pathologist informing that he/she rejects the diagnosis is received, the response receiver unit 16 sends this information to the image transmission commander unit 14 and the diagnosis requesting unit 15. Then, the image transmission commander unit 14 sends a transmission request to the IDB server 2 so that the VS image data be sent to the local server 4c corresponding to the next prioritized pathologist after the three top pathologists to whom the VS image data has already been sent. In addition, the diagnosis requesting unit 15 sends a notification of diagnosis request and an inquiry to a pathologist prioritized immediately next to the pathologist to whom the latest diagnosis request has been sent.

When the information regarding the completion of diagnosis is received, for example, through transmission of a notification informing that the diagnosis has been completed together with a summarized report of the results of the pathologic diagnosis, from the pathologist to the RPS 1, the diagnosis completion receiver unit 17 sends this information to the image deletion commander unit 18.

When the information from the response receiver unit 16 notifying that the pathologist to whom the diagnosis request has been sent can do the diagnosis is received, the image deletion commander unit 18 sends a deletion request to the local servers 4a to 4c to which the VS image data has already been sent, so that the VS image data be deleted, except for one of the local servers 4a to 4c which corresponds to the pathologist to whom the latest diagnosis request has been sent. In addition, when the information regarding the completion of diagnosis from the diagnosis completion receiver unit 17 is received, the image deletion commander unit 18 sends a deletion request to the concerned one of the local servers 4a to 4c which corresponds to the pathologist to whom the latest diagnosis request has been sent, so that the VS image data be deleted.

Hereunder is a description of the operations of the pathologic diagnosis processor 1 and the pathologic diagnosis-processing system 100 according to this embodiment thus configured in such a manner.

When the personal doctor in charge at the primary hospital 8 determines that the patient needs to be pathologically diagnosed, a specimen is taken from the lesioned site of the patient and this specimen is sent from the primary hospital 8 to the inspection agency 7 together with a barcode of the specimen ID. Moreover, when the patient ID, the specimen ID, and the diagnosis request information are input into the RPS 1 and when the request for pathologic diagnosis of the patient is received, pathologists suitable for the request for diagnosis of the patient are selected from registered pathologists.

When a VS image of the specimen is created in the inspection agency 7, data of the VS image are sent from the IDB server 2 to the local servers 4a and 4b which correspond to the top three prioritized pathologists among the selected pathologists. Subsequently, a diagnosis request is sent to the first prioritized pathologist.

If the first prioritized pathologist receiving the diagnosis request accepts the diagnosis request, he/she sends the response of acceptance to the RPS 1. By so doing, the stored VS image data is deleted from the local server 4b, other than the local server 4a corresponding to the first prioritized pathologist. The first prioritized pathologist accesses from the pathologist terminal 3a used by him/herself to the local server 4a to have a view of the VS image to thereby conduct the pathologic diagnosis. When the diagnosis has been completed, the pathologist sends the notification of completion to the RPS 1. Accordingly, the VS image stored in the local server 4a is deleted.

On the other hand, if the first prioritized pathologist rejects the diagnosis request, he/she sends a response of rejection to the RPS 1. By so doing, the RPS 1 sends the VS image data to the local server 4c which corresponds to the fourth prioritized pathologist, and sends a diagnosis request to the second prioritized pathologist. Then, if the second prioritized pathologist also rejects the diagnosis request, the diagnosis request will be sent to the next-to-next pathologist sequentially in the order of high-to-low priority of pathologists.

In this way, according to this embodiment, even in the case where the patient is subjected to a pathologic diagnosis in the primary hospital 8, a diagnosis request can be made to a pathologist suitable for the diagnosis request. This provides an advantage in that an appropriate pathologic diagnosis corresponding to each diagnosis request can be conducted, in such a way that, for example, a diagnosis request can be made to a pathologist who can promptly start to diagnose at the time of soon after receiving the diagnosis request if the diagnosis result is urgently required, and a diagnosis request can be made to a highly specialized pathologist when it comes to a difficult case of a disease.

In addition, before making a diagnosis request to pathologists, the VS image data has been previously sent to the local servers 4a to 4c which are capable of high speed communication with the pathologist terminals 3a to 3d used by the pathologists, so that the pathologist terminals 3a to 3d acquire the VS image data via the high speed network 6. By so doing, as compared to the case of accessing to the IDB server 2, the advantage is that the VS image data can be quickly acquired by the pathologist terminals 3a to 3d and a distant pathologist can smoothly proceed with the diagnosis even if the data size of the VS image is extremely large.

Furthermore, overlapping transmissions of the same VS image data to the local servers 4a to 4c can be prevented beforehand. Also, when the VS image data becomes unnecessary anymore, the VS image data can be promptly deleted from the local servers 4a to 4c. By so doing, loads on the local servers 4a to 4c can be alleviated.

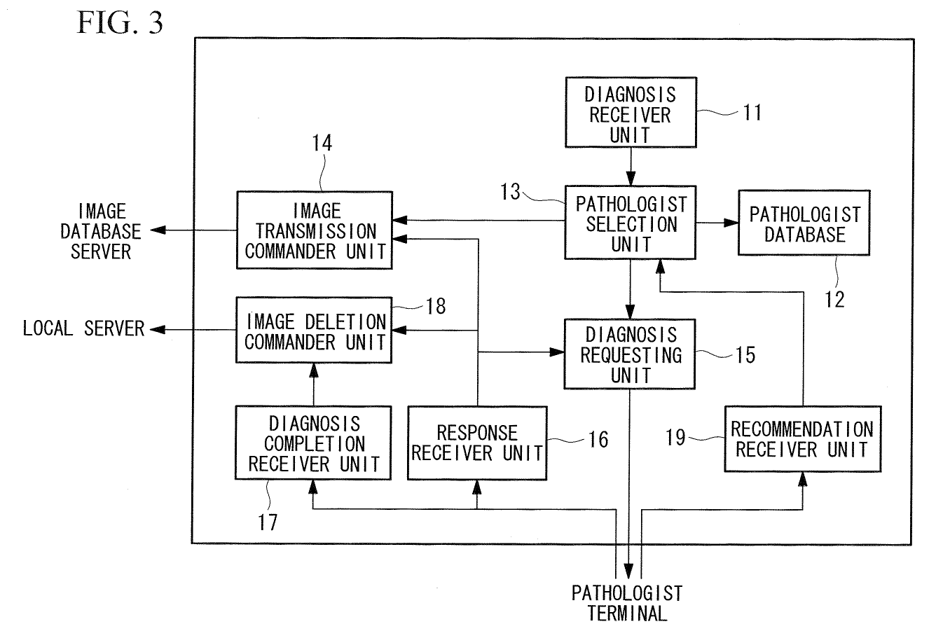

In the above-mentioned embodiment, there may also be provided, as shown in FIG. 3, a recommendation receiver unit 19 which receives a recommendation for a different pathologist from a pathologist to whom the RPS 1 has sent the diagnosis request.

If the pathologist determines that a different pathologist is more preferable to diagnose regarding the diagnosis request received from the RPS 1, a recommendation for the different pathologist can be made to the RPS 1 by sending information of the different pathologist, for example, the name of the different pathologist.

When the recommendation receiver unit 19 receives the recommendation for the different pathologist from the pathologist to whom the diagnosis request has been originally sent, the RPS 1 inquires about the information of the recommended pathologist to the pathologist database 12. Then, after having the VS image data sent from the IDB server 2 to a local server which corresponds to the recommended pathologist, the RPS 1 sends a diagnosis request to the recommended pathologist.

By so doing, when it comes to a rare case of a disease which is difficult for the pathologist database 12 to cover, or in such a case, a diagnosis request can be made to a more suitable pathologist by using networks between pathologists. In addition, by recommending a different pathologist in such a manner after the formerly requested pathologist has conducted the diagnosis, it becomes also possible to obtain a second opinion of the different pathologist. By so doing, diagnoses by a plurality of distant pathologists can be readily achieved, and difficult cases of diseases can be more accurately diagnosed.

Moreover, in the above-mentioned embodiment, the image transmission commander unit 14 may also issue a command to send the VS image data from the IDB server 2 to a local server belonged to by the primary doctor terminal used by the personal doctor in charge of the patient. The local server of this case is also connected to the primary doctor terminal of the personal doctor via a high speed network, likewise of the local servers 4a to 4c belonged to by the pathologist terminals 3a to 3d.

By so doing, the VS image data can be quickly acquired as compared to the case where the personal doctor accesses to the IDB server 2 of the inspection agency 7 to have a view of the VS image.

In addition, in the above-mentioned embodiment, the RPS 1 waits for the completion of transmissions of the VS image data to the local servers 4a to 4c before sending the diagnosis request. However, instead of this configuration, the RPS 1 may also send the diagnosis request to the IDB server 2, upon the passage of a predetermined time after sending a request to transmit the VS image data, and before the completion of transmissions of the VS image data.

By so doing, the pathologist to ask for the final diagnosis request can be more quickly determined so that the processing efficiency of the RPS 1 can be improved.

What is claimed is:

1. A processor for pathologic diagnosis, which is connected to a first network of a processing system for pathologic diagnosis comprising: an image storage server which is connected to said first network, and which stores digital image data of a specimen taken from a patient, in an associated manner with identification information of the patient; pathologist terminals which are connected to a second network, which is connected to said first network, that is capable of higher speed communication than the first network, and which are used by previously registered pathologists; and a local server which is connected to said second network, wherein the processor for pathologic diagnosis comprises:
a diagnosis receiver unit which receives the identification information of the patient and diagnosis request information;
a pathologist information storage unit which stores information of said pathologists;
a pathologist selection unit which makes an inquiry to said pathologist information storage unit based on the diagnosis request information received by said diagnosis receiver unit, and selects a pathologist suitable for said diagnosis request information;
an image transmission commander unit which issues a command to send digital image data of said patient stored in said image storage server, to a local server connected to said second network belonged to by a pathologist terminal used by the pathologist selected by the pathologist selection unit; and
a diagnosis requesting unit which sends a request for diagnosis of the specimen of said patient, to the pathologist selected by said pathologist selection unit, after said digital image data has been sent to said local server by the image transmission commander unit.

2. A processor for pathologic diagnosis according to claim 1, wherein said pathologist selection unit selects a plurality of such suitable pathologists by prioritizing them, and
said image transmission commander unit issues a command to send said digital image data to respective local servers belonged to by pathologist terminals used by the plurality of pathologists, sequentially in the order of priority of pathologists.

3. A processor for pathologic diagnosis according to claim 1, wherein the processor comprises a response receiver unit which receives a response regarding the acceptance or rejection of the diagnosis, in reply to the diagnosis request from said diagnosis requesting unit,
if said response receiver unit receives a response from said pathologist informing that he/she rejects the diagnosis, said image transmission commander unit issues a command to send said digital image data to said local server belonged to by a pathologist terminal used by a pathologist prioritized next to the pathologist to whom said digital image data has already been sent, and
said diagnosis requesting unit sends a diagnosis request to a pathologist prioritized immediately next to the pathologist to whom the latest diagnosis request has been sent.

4. A processor for pathologic diagnosis according to claim 1, wherein said image transmission commander unit determines whether or not said digital image data has already been sent to the addressed local server, and if the data has already been sent thereto, the unit cancels the transmission of said digital image data.

5. A processor for pathologic diagnosis according to claim 1, wherein the processor comprises
a diagnosis completion receiver unit which receives a notification from said pathologist terminal informing that the diagnosis has been completed, and
an image deletion commander unit which issues a command to the local server belonged to by said pathologist terminal, from which the notification of the completion of diagnosis has been received by the diagnosis completion receiver unit, so that said digital image data be deleted.

6. A processor for pathologic diagnosis according to claim 1, wherein the processor comprises a recommendation receiver unit which receives a recommendation for a different pathologist from the pathologist to whom the diagnosis request has been sent from said diagnosis requesting unit, and
if the recommendation for the different pathologist is received by the recommendation receiver unit, said image transmission commander unit issues a command to send said digital image data to the local server belonged to by a pathologist terminal used by said different pathologist, and thereafter said diagnosis requesting unit sends a diagnosis request to said different pathologist.

7. A processing system for pathologic diagnosis comprising:
an image storage server which is connected to a first network, and which stores digital image data of a specimen taken from a patient, in an associated manner with identification information of the patient;
pathologist terminals which are connected to a second network, which is connected to said first network, that is capable of higher speed communication than the first network, and which are used by previously registered pathologists;
a local server which is connected to said second network; and
a processor for pathologic diagnosis which is connected to said first network, wherein
the processor for pathologic diagnosis comprises:
a diagnosis receiver unit which receives the identification information of the patient and diagnosis request information;
a pathologist information storage unit which stores information of said pathologists;
a pathologist selection unit which makes an inquiry to said pathologist information storage unit based on the diagnosis request information received by said diagnosis receiver unit, and selects a pathologist suitable for said diagnosis request information;
an image transmission commander unit which issues a command to send digital image data of said patient stored in said image storage server, to a local server connected to said second network belonged to by a pathologist terminal used by the pathologist selected by the pathologist selection unit; and
a diagnosis requesting unit which sends a request for diagnosis of the specimen of said patient, to the pathologist selected by said pathologist selection unit, after said digital image data has been sent to said local server by the image transmission commander unit.

8. A processing system for pathologic diagnosis according to claim 7, wherein the system comprises a primary doctor terminal which is connected to said second network and is used by a personal doctor in charge of said patient, and
said image transmission commander unit issues a command to send said digital image data to a local server belonged to by said primary doctor terminal.
